(19) United States
(12) Patent Application Publication
(10) Pub. No.: US 2002/0114453 A1
(43) Pub. Date: Aug. 22, 2002

(54) System and method for secure cryptographic data transport and storage

(76) Inventors: Thomas G. Bartholet, Laguna Hills, CA (US); Hugo Fruehauf, Laguna Niguel, CA (US); Derek C. Au, Huntington Beach, CA (US)

Correspondence Address: MORRISON & FOERSTER, LLP, 555 WEST FIFTH STREET, SUITE 3500, LOS ANGELES, CA, 90013-1024, US

(21) Appl. No.: 09/790,021

(22) Filed: Feb. 21, 2001

(51) Int. Cl. H04L 9/00

(52) U.S. Cl. 380/44; 713/153

(57) ABSTRACT

A method and apparatus for secured storage and communication of data using in situ cryptographic key generation facilities whereby data to be stored in a data storage system (e.g., a Storage Area Network) can be encrypted using encryption keys that are generated by locally deployed cryptographic key generators, which generate encryption keys based upon setup configurations that include time or event memory data. The setup configurations used to generate encryption keys can also be associated with the encrypted data by a data marker and stored such that, upon decryption of the same data at a later time period, the data marker may retrieve the stored setup configuration, which is then used to configure a locally deployed cryptographic key generator for purposes of generating the appropriate decryption keys to decrypt the data, whereby the cryptographic key generator used for generating encryption keys need not be the same cryptographic key generator used for generating decryption keys.

### BACKGROUND OF THE INVENTION

1. Field of the Invention

The present invention relates to an apparatus and method for cryptographically transmitting and storing data through the use of in situ key generators. The invention described herein is especially useful as the preferred but not limiting method for end-to-end “secure storage” applications in which cryptography is used to securely store data, to securely transfer data within storage area networks, and to securely transport data to and from storage within an authorized user community.

2. Description of Related Art

Conventionally, information being transmitted through electronic media is not secure and is vulnerable to interception by a third party. For example, a telephone conversation between two people over public telephone wires may be “tapped” by a third party. In another instance, an e-mail transmitted over the Internet can be “intercepted” by an unknown entity, which may later use the information contained in the e-mail to the detriment of the author and/or recipient of the e-mail. This is also the case for stored data, which is often accessed or retrieved by unauthorized persons, even if the data was thought to have been stored securely.

Conventionally, stored data is most commonly protected by password protection where the use of the approved password by anyone communicating with the storage system can gain full access to read from, write to, or even create files for which that password is valid and in effect. The user of such a password can be anyone who has learned the password, and he or she can be located anywhere, even at computer workstations or access devices outside those of the anticipated users. Further, communication of the data to and from storage may not be encrypted.

A more sophisticated method used to maintain the confidentiality of communicated or stored data involves the use of cryptography where data is encrypted and decrypted for transmission or storage. The encryption process, typically involving the use of a cryptographic algorithm, makes the information undecipherable to unintended recipients. In order to decipher the encrypted information, a recipient must possess a unique piece of information (i.e., a “key”) that can be used with the cryptographic algorithms to successfully decrypt the encrypted data. More specifically, an encryption key is typically a data string which, when combined with another set of data according to an algorithm, produces a data output that is unintelligible to third parties. To decipher the data output, one must use a decryption key. In most instances, the encryption key is identical to the decryption key for a given algorithm.

In conventional cryptographic systems based on the use of keys, the sender creating the key must distribute it to the intended recipients authorized to decrypt the transferred or stored data. Operations and services relating to the use and distribution of keys are commonly referred to as key exchange or key management systems. More specifically, a key management infrastructure creates, distributes, authenticates, certifies, and often changes and/or revokes keys used within a cryptographic user community. Key management can be accomplished either manually or in an automated fashion, physically transferring keys or using electronic means to do so. It is intended in a conventional cryptographic system that only authorized users be in possession of the appropriate keys that can encrypt or decrypt data transferred or stored. Accordingly, to maintain the security of a cryptographic system, an effective key management infrastructure must prevent unintended recipients from acquiring knowledge of the encryption and/or decryption keys.

Often, the process of key distribution for data transfer or storage, results in either unintentional disclosure of the keys to third parties or interception/extraction of the keys or key material by unauthorized entities. Such unauthorized entities may then use the keys from any computer workstation or access device to encrypt and send or store bogus information or to decipher encrypted, legitimate information in transmission or storage. To reduce the chances for system compromise, keys can be changed from time to time. Cryptographic systems that do not change keys on a frequent basis may eventually become vulnerable to computer “hackers,” who, given sufficient time, can use powerful computers to decipher/extract the encryption algorithm and derive the encryption keys. On one hand, key changes enhance security, while on the other hand; the process burdens conventional key management systems and again jeopardizes security through the key change process. To decrease the likelihood of someone deciphering the encrypted information, designers of conventional encryption systems typically enhance security protection by using stronger encryption algorithms that are based on longer encryption codes and/or implementing a more sophisticated key management infrastructure. Additionally, complex key management infrastructures that change and distribute keys on a frequent basis increase logistics and the cost of maintaining a cryptographic communication or data storage system.

### SUMMARY OF THE INVENTION

The inventions described in the referenced patents enhance significantly the security of cryptographic systems by applying an innovative alternative to conventional methods of key management. In particular, the inventions facilitate an infrastructure within which data is secured using in situ generated encryption and decryption keys. More specifically, preferred embodiments of these inventions provide a pseudo-random key generator that can be deployed at various locations within secured communication and/or data storage systems, substantially eliminating any need for key distribution and capable of keeping the keys unknown to all parties involved. In particular, a pseudo-random key generator with given input values for set-up configuration parameters, according to the preferred embodiments of the invention, generates a set of key sequences based on a pseudo-random method such that, for any given period of time, the pseudo-random key generator generates a key unique for that time period. By using the in situ pseudo-random key generators, no encryption/decryption keys need be transferred between users. Rather, each user can generate his own key locally and be able to encrypt/decrypt the communication using those locally generated keys. For instance, in a communication community where two users independently possess in situ key generators, so long as the generators are configured identically, the users may communicate with each other in encryption mode without ever having to transmit the keys over the communication lines.

The present invention described herein focuses on unique applications of in situ key generators as they relate to generating cryptographic keys to encrypt/decrypt data being stored or retrieved. One concept of the preferred embodiment of the present application revolves around the ability for multiple users to encrypt/decrypt data files for storage without the need to transmit or store encryption/decryption keys with the data files. The present application is useful in encrypting and decrypting data within a storage system (e.g., a storage area network or “SAN” or network-attached storage or “NAS”) that is accessed by a multitude of authorized users. Specifically, the preferred embodiment of the present invention “tags” or associates encrypted data with information relating to the configuration of the in situ key generator that generated the encryption key used for encrypting the data. Such information may include a time stamp, an event, file identification, storage media segment/block identification, etc. Upon retrieval of the data at a later time by either the same user or by a different user, the tagged configuration information is identified and used to configure the in situ key generator for purposes of generating the appropriate decryption key to be used to decrypt the data. Each in situ key generator may have its own user identification functions to authorize only certain users to communicate via that key generator with one or more particular set-up configurations, thus determining what configurations that user may employ for cryptographic key generation. This latter feature assures that unauthorized users may not send or receive encrypted data via that key generator.

More than one in situ key generator may be used by a single user to accomplish transmission and storage functions of the data. The choice of employing multiple in situ generators is a design trade-off concerning workload on the key generators, management of key generator configurations, related circuit design and communication management, all versus cost and space. In the preferred embodiments described herein, both common and separate pseudo random key generators (PKGs) are employed in situ for transmission and storage. In other words, one PKG engine may serve both transmission and storage. In an another embodiment, one PKG serves only the storage encryption and decryption functions while another handles transmission or communication encryption and decryption. Each such PKG may be supplemented with additional PKGs as workload may require. A variety of configurations and utilizations of PKG's for end-to-end transmission and storage encryption are possible. Such flexibility allows tailorable combinations of security separations, processing workload management, and resulting cost. Preferred embodiments described herein are representative of that flexibility, without being limiting.

In another embodiment, an authorized user may communicate cryptographically with the storage system via his in situ generator over a LAN or WAN, using a set-up configuration specific to him individually or to one of his user groups. The LAN or WAN connection to the storage system may be public or private. In a storage system where a single key generator handles transmission and storage encryption, the same encryption may be used for both transmission and storage. In a storage system where separate key generators handle transmission and storage encryption, one key generator in the storage system may serve as the transmission gateway to and from storage. In this case, a first gateway in situ generator may decrypt incoming data and directly pass it in the clear or still encrypted to a separate storage in situ key generator. A separate storage in situ generator may re-encrypt the data or further encrypt the data with an additional layer of encryption, using one or more set-up configurations, which may be unique to the storage system, and which may also vary by authorized access for the user, user group, or content. The storage system may also store the received encrypted content “as is” (i.e., without decryption or further encryption). If the storage key generator uses set-up configurations and synchronization unique to the storage system, then these may vary by other characteristics of the content storage (including but not limited to start time and date of storage, memory location of storage or amount of data stored), which may be useful to subsequent data content management for such actions as archiving or purging files or allocating storage resources. Similarly, the gateway in situ key generator may generate keys to be used for encrypting data retrieved via the storage in situ key generator, for transmittal via a set-up configuration shared with the particular user's in situ generator.

Within a SAN, common transfer and storage encryptions may also be used among the networked storage devices. Such a network is just an extended yet integrated storage system. User access points to the SAN may be through gateway in situ key generators of the SAN possessing user configurations. Within a wide area SAN using the public network for stored content distribution (a virtual SAN), separate transmission key generations unique to the SAN may be desired for independent security over its communications links. If so, then each storage location within the wide area SAN could use gateway key generator configurations specifically for communication with other storage locations of the SAN. Gateway in situ key generators for user access and for wide area SAN stored content distribution may be the same PKGs used for storage encryption.

The preferred embodiments of the present invention for cryptographic transmission and storage have the following advantages over conventional implementations:

No conventional key management infrastructure is required for cryptographic data transmission and storage of files and data, since all the keys are internally generated by the in situ key generators for use in the authorized network;

Only information as may be necessary to synchronize or configure the in situ key generator is associated with the encrypted file. No keys need be stored with the data or file or anywhere else;

The cryptographic keys can be made unknown and remain unknown to users during the process of transmission, storage, and retrieval of stored data;

The encryption keys can be automatically changed for transmission or storage at a pre-set frequency; including dividing any given data file into numerous segments each with its own encryption key;

For files or data being encrypted for storage that take less time to store than the pre-set key change period, an event driven key generator can be implemented, changing keys for example, after a certain number of bit packets rather than certain periods of time;

Data stored on removable storage media can be secured so that it cannot be read unless taken to a storage system with a key generator identically configured to the one used to encrypt the data;

The present invention is openly compatible to centralized and decentralized data storage infrastructures and networks (such as Fibre Channels, SANs, or NAS) or mixtures thereof;

Encryption for storage may be common with or unique from encryption for transmission to and from storage. Multi-layer encryption may be employed requiring separate decryption for each layer, even via separate key generators;

Management of user access and content storage may be accomplished directly through the encryption configurations allotted to users and content providers;

The data can be secured for transport and storage with the most advanced, standard encryption algorithms available, ones already proven and accepted;

User authentication may be accomplished directly through the encryption and user identification functions necessary to enable the key generator set-up configuration required for successfully processing that encryption;

In situ key generators can be located within the transmission and storage network systems, within the storage apparatus or drives, or in the associated terminal or network control stations.

### DETAILED DESCRIPTION OF PREFERRED EMBODIMENTS

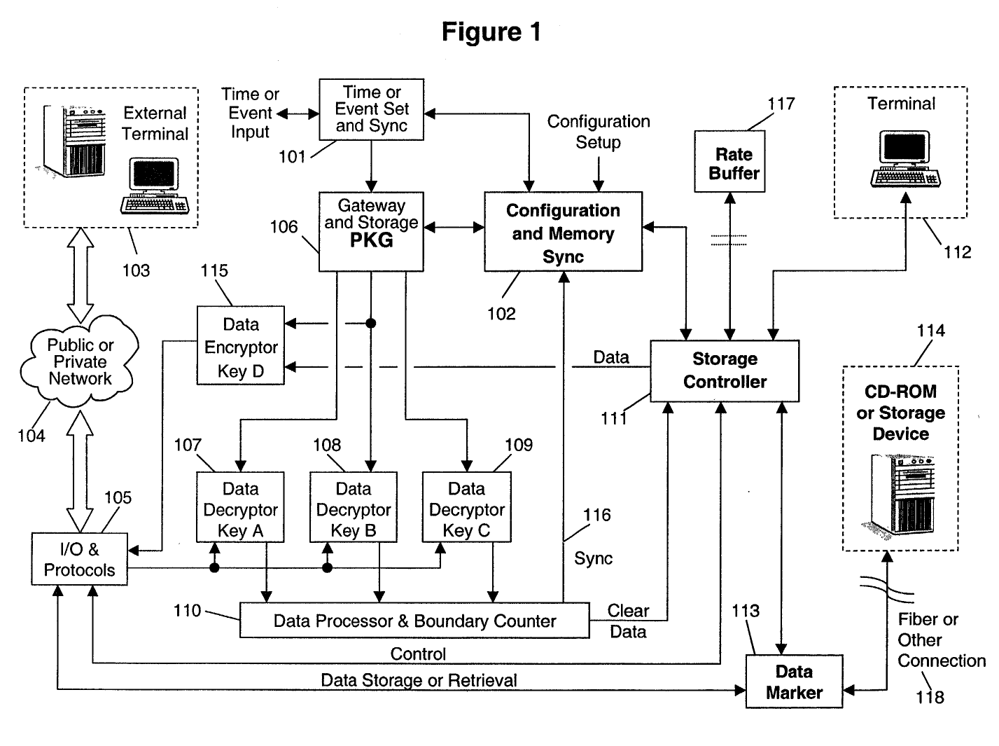

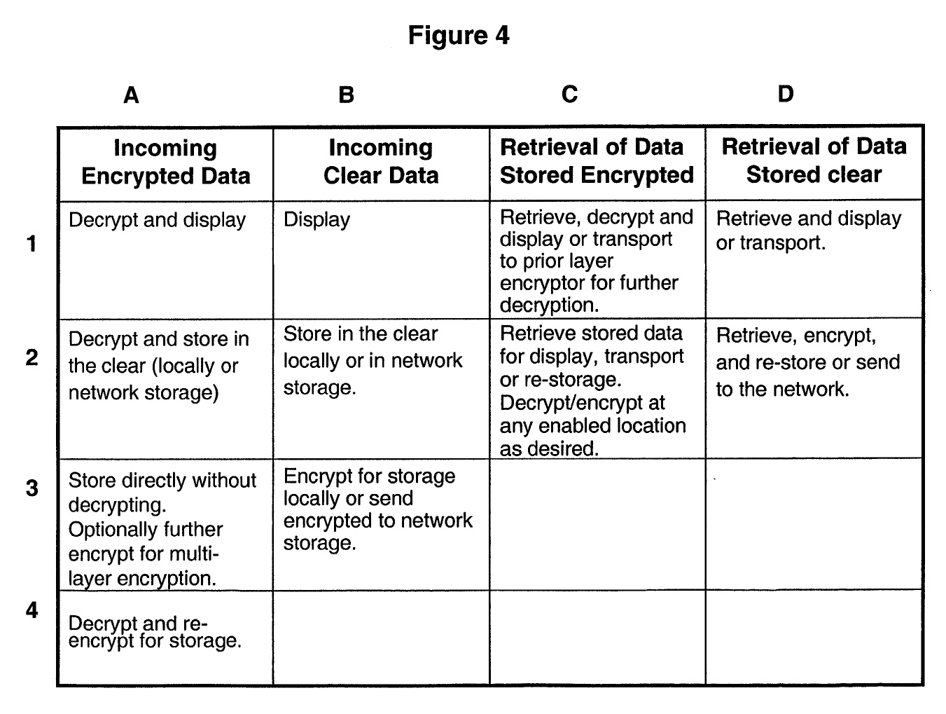

The embodiments of the present invention (but not limited to such) will now be described with reference to FIGS. 1-3. In addition, FIG. 4 lists possible alternative operating modes as to data transmission, storage and retrieval for the embodiments illustrated in FIGS. 1-3. Accordingly, the specification refers to FIG. 4 periodically while describing the embodiments detailed in FIGS. 1, 2, and 3. It should be noted that, in FIGS. 1-3, the blocks are interconnected and named as examples only in order to demonstrate the functional flow and operation of these embodiments; the actual hardware can be arranged in alternative configurations and given other names to satisfy the embodiments of this submittal.

FIG. 1 illustrates a secured communication and storage retrieval system in accordance with a preferred embodiment of the present invention whereby an in situ pseudo random key generator (“PKG”) 106 is used. The PKG security module 106 is preferably used to generate cryptographic keys to secure both cryptographic data transport and the cryptographic data storage and retrieval actions. As previously mentioned, a pseudo-random key generator with given input values for set-up configuration parameters, according to the embodiments of the present invention, generates a set of key sequences based on a pseudo-random method such that, for any given period of time and given set of configuration parameters, the pseudo-random key generator generates a key unique for that time period and configuration. For instance, in a communication network where two users possess the same PKG module having the same configuration, including time synchronization, data may be encrypted and decrypted by the sender and receiver, respectively, without having to transmit or transport the cryptographic keys beforehand.

In an alternative scheme, the receiver may elect to employ a multiple number of decryptors, wherein each of the three decryptors are supplied with a generated cryptographic key, and wherein the cryptographic keys are generated at different but adjacent time periods such that, in case the transmission and receiving PKGs become out of sync, or in case there is data transmission delay, the receiver can still decrypt the data. More details of the multiple decryptor scheme will be illustrated below with reference to FIG. 1.

With further reference to FIG. 1, when decrypting data that were previously encrypted and stored, the PKG accepts associated input from a data marker 113 to establish its needed configuration as well as the needed time and/or event synchronization. Accordingly, the PKG module 106 may be part of a data communications network terminal or be part of the storage apparatus directly. The PKG 106 can generate and use the same keys for both communication and storage or use separate encryption keys for communication versus storage.

In accordance with the preferred embodiment of the present invention, all the PKGs in the authorized network community are preferably synchronized (in time or by event) via the method shown in FIG. 1 by a Time or Event Set and Sync block 101, in order to generate identical encryption and decryption keys within that user community. It is also preferable that all the communicating PKGs in the user community are identically configured in terms of the PKG configuration settings (including the period for frequent key changes as desired), as shown by the “Configuration Setup callout at the Configuration Memory and Key Sync block 102. In the following descriptions of operating modes, it is assumed that the incoming encrypted data was encrypted with a PKG encryption module somewhere else in the authorized user community. These operating modes are identified by the alphanumeric axis labels of the table in FIG. 4.

In the case of incoming encrypted data destined for decryption and display on a computer terminal (Operating Mode A1 of FIG. 4), the encrypted data from an External Terminal block 103 is transmitted via a public or private Network 104 to the I/O & Protocols block 105. For a given time or event, the Gateway and Storage PKG 106 preferably generates the same keys as those generated by a PKG in an external terminal that is sending the encrypted data to block 105. The generated keys are sent to the Data Decryptors, blocks 107, 108, and 109; that is, a previous key period—Data Decryptor Key A, block 107, a present key period—Data Decryptor Key B, block 108, and the next key period—Data Decryptor Key C, block 109. With all three decryptors working in parallel, preferably one of the three will succeed in decrypting the incoming data. This is known on a packet-by-packet basis by a portion of a known header or flag information being properly decrypted with the correct key by only one of the three decryptors. This known information in the data may come from added overhead put into the data during the encryption process or may be from a header already available from other network requirements such as a TCP or IP address or other such network related protocols. All three decryptor outputs are sent to the Data Processor & Boundary Counter block 110, which in turn passes only the correctly decrypted packets to the Storage Controller block 111.). The data is then passed on to the Terminal block 112 for display. In all operating modes described for FIG. 1, the Rate Buffer block 117 serves as a random memory device for data overflow, to cover any mismatches between data rates for storage, for communication or for display.

In the case of incoming encrypted data destined to be stored in the clear locally or sent back out for storage on a network storage device (Operating Mode A2, of FIG. 4), the encrypted data from an External Terminal block 103 is transmitted via a Public or Private Network 104 to the I/O & Protocols block 105. The Gateway and Storage PKG block 106 generates the same keys as those generated by a PKG in the external terminal, sending keys to three decryptors. These keys power the Data Decryptors, blocks 107, 108, and 109; that is, a previous key period—Data Decryptor Key A, block 107, a present key period—Data Decryptor Key B, block 108, and the next key period—Data Decryptor Key C, block 109. With all three decryptors working in parallel, only one of the three will succeed in decrypting the incoming data, as determined by the Data Processor & Boundary Counter block 110, which passes the decrypted data to the Storage Controller block 111, which in turn passes the data to Data Marker block 113. Since the data or file is to be stored in the clear, no data marker is reserved for the decrypted data. If the decrypted data is to be stored locally, it is passed to the CD-ROM or Storage Device block 114 for storage via Fiber or Other Connection 118. If it is to be sent back out for storage on a network storage device, the decrypted data is passed back into the Network 104 via the I/O & Protocols block 105.

In the case of incoming encrypted data destined for storage without first decrypting the data (Operating Mode A3 of FIG. 4), the encrypted data from an External Terminal block 103 is transmitted via a Public or Private Network 104 to the I/O & Protocols block 105. From here it is passed directly to the Data Marker block 113, where the still encrypted file or data is marked or associated with the appropriate configuration data (such as but not limited to set-up configuration information, time stamp, event value, file number, file length, storage media segment/block ID, etc.) for later configuration of the PKG when the data is subsequently retrieved for decryption. The marked and still encrypted data is then passed to the CD-ROM or Storage Device block 114 for storage via Fiber or Other Connection line 118.

For optional multi-layer encryption schemes, the incoming encrypted content received over the Network 104 is passed by I/O and protocols 105 to the Data Marker 113 for marking for later decryption, if desired, and then via the Storage Controller 111 to the Data Encryptor 115 for an additional layer of encryption. The multi-layer encrypted content then passes through I/O and Protocols 105 to the Data Marker 113 to be marked with data necessary to enable decryption of this last layer of encryption. From there, the data may be further encrypted as before or moved to a Storage Device 114.

In the case of incoming encrypted data destined to be decrypted and again re-encrypted for storage (Operating Mode A4 of FIG. 4), the encrypted data from an External Terminal block 103 is transmitted via a Public or Private Network 104 to the I/O & Protocols block 105. The Gateway and Storage PKG block 106 generates the same keys as those generated by a PKG in external terminals, sending keys to three decryptors. These keys are delivered to the Data Decryptors, blocks 107, 108, and 109; such that keys generated at adjacent key periods are consecutively distributed to the three decryptors. For instance, during a previous key period—Data Decryptor Key A is supplied to block 107, at present key period—Data Decryptor Key B is supplied to block 108, and the next key period—Data Decryptor Key C is supplied to block 109. With all three decryptors working in parallel, only one of the three will succeed in decrypting the incoming data with the appropriate key generated at the appropriate time, as determined by the Data Processor & Boundary Counter block 110. The Data Processor in turn passes the decrypted data to the Storage Controller block 111. Since the data is to be re-encrypted under this particular mode of operation, the Storage Controller block 111 passes the data to the Data Encryptor Key D block 115, which encrypts the data again and passes it to the I/O & Protocols block 105, which then passes the data to Data Marker block 113. At the data marker 113, the data is marked or associated with the appropriate configuration data (set-up configuration information, time stamp, event value, file number, file length, or storage media segment/block ID, etc.) for later decryption upon retrieval and sent to be stored in the CD-ROM or Storage Device block 114 via Fiber or Other Connection line 118.

In the case of incoming clear data destined to be displayed on Terminal 112 without need to be stored (Operating Mode B1 of FIG. 4), the clear data from an External Terminal block 103 is transmitted via a Public or Private Network 104 to the I/O & Protocols block 105. From there it bypasses the decryptors, preferably through the Data Marker block 1 13, to the Storage Controller block 111 and on to Terminal 112 for display.

If the clear data is destined for storage in the clear (Operating Mode B2 of FIG. 4), the operating mode is the same as that in B1 above except the Data Marker block 113 passes the data directly to the CD-ROM or Storage Device block 114 via Fiber or Other Connection line 118.

In the case of incoming clear data destined to be encrypted for local storage or sent back out encrypted for storage on a network storage device (Operating Mode B3 of FIG. 4), the clear data from an External Terminal block 103 is transmitted via a Public or Private Network 104 to the I/O & Protocols block 105. From there it bypasses the decryptors, going through the Data Marker block 113, to the Storage Controller block 111, to the Data Encryptor Key D block 115. The Gateway and Storage PKG block 106 generates the keys for the present synchronized time, passing them to the Data Encryptor Key D block 115, which then encrypts the incoming clear data. The data is then passed back to the I/O & Protocols block 105 to the Data Marker block 113, at which the data is marked or associated with the appropriate configuration data that may include one or all of the following: set-up configuration information, time stamp, event value, file number, file length, or storage media segment/block ID, etc. The data is then sent to be stored in the CD-ROM or Storage Device block 114 via Fiber or Other Connection line 118. If the data is instead to be sent back out for storage on a network storage device, it is passed back into the Network 104 via the I/O & Protocols block 105 and upon arrival at the external terminal is marked or associated with the appropriate configuration data before the data is stored.

In the case of retrieving data that has been stored encrypted, destined to be displayed (Operating Mode C1 of FIG. 4), the encrypted data from the CD-ROM or Storage Device block 114 is sent to the Data Marker block 113. There, the appropriate cryptographic configuration data (e.g., set-up configuration information, time stamp, event value, file number, file length, or storage media segment/block ID, etc.) associated with the file is recovered and sent to the Storage Controller block 111, which passes it to the Configuration Memory and Key Sync block 102. This block determines the appropriate configuration for the PKG to generate the needed keys to decrypt the file. Once the configuration information is determined, it is sent to the Gateway and Storage PKG block 106, which sends the appropriate keys to the Data Decryptors, blocks 107, 108, and 109. Once this is accomplished, the encrypted data from storage is sent from the Data Marker 113 via the I/O & Protocols block 105 to the decryptors. With all three decryptors working in parallel, preferably only one of the three will succeed in decrypting of the incoming data, as determined by the Data Processor & Boundary Counter block 110, which in turn passes the decrypted data to the Storage Controller block 111 and on to the Terminal 112 for display.

However, if a prior layer of encryption still needs decryption, the Data Marker 113 then sends the cryptographic configuration data for that layer to the Storage Controller 111 for repetition of the previously described decryption cycle. If instead the prior layer encryption is to be decrypted at a different location, that encrypted data is sent by the Storage Controller 111 through the I/O and Protocols 105 via the Network 104 to the desired External Terminal 103. That encrypted data and cryptographic configuration data may be further encrypted for said transmission by Data Encryptor Key D block 115.

A unique data decryption synchronizer is implemented to insure that the clock/timing/event functions involved with the decryption of the file coming from storage, stays in sync with the clock/timing/event functions which were originally involved when the file was encrypted for storage. This synchronizer functionality involves the boundary counter portion of the Data Processor & Boundary Counter block 110, the Sync line 116, the key sync portion of the Configuration Memory and Key Sync block 102, the Time or Event Set and Sync block 101, and the Gateway and Storage PKG block 106. The synchronization process is as follows:

As the data that is retrieved from storage is being decrypted, it is preferable that the Data Decryptor Key B block 108 will be doing the decrypting. If block 107 or 109 is doing the decrypting for an extended period of time, the boundary counter portion of the Data Processor & Boundary Counter block 110 determines the time or event offset and whether it is behind or ahead of the time or event sequence. The information is sent via Sync line 116 to the Configuration Memory and Key Sync block 102, which increments the Gateway and Storage PKG block 106 up or down via the Time or event Set and Sync block 101 in order that the decryption is done with the center decryptor, block 108.

In the case of retrieving data that has been stored encrypted, by any network terminal for display or re-storage (Operating Mode C2 of FIG. 4), all the above functions of operating mode C1 apply for the terminal doing the decrypting. What changes is simply that the requesting network terminal such as shown in block 103 requests the file to be extracted from the CD-ROM or Storage Device block 114. This file is thus sent back out to the requesting terminal via the public or private Network 104. The file may be decrypted at the storage location to transmit to the requesting terminal in the clear or via re-encryption for transmission, or it may be transmitted without decryption for decryption at the requesting terminal. The appropriate cryptographic configuration data needed for decryption is retrieved by the Data Marker 113 at whichever location it was stored and transmitted as required for use in decrypting the data.

In the case of retrieval of data stored in the clear for display (Operating Mode D1 of FIG. 4), the data is extracted from the CD-ROM or Storage Device block 114 and is passed via the Data Marker block 113 and the Storage Controller block 111 to the Terminal 112 for display. For communication to other networks, the clear data is passed via the Data Marker 113 to the I/O and Protocols 105 for transmission across the Network 104 to an External Terminal 103.

In the case of retrieval of data stored in the clear for later encryption to be re-stored locally or sent out to the network for storage elsewhere (Operating Mode D2 of FIG. 4), the data is extracted from the CD-ROM or Storage Device block 114 and is passed via the Data Marker block 113 and the Storage Controller block 111 to the Data Encryptor Key D block 115 to be encrypted. From there it follows the same process previously described in operating mode B3.

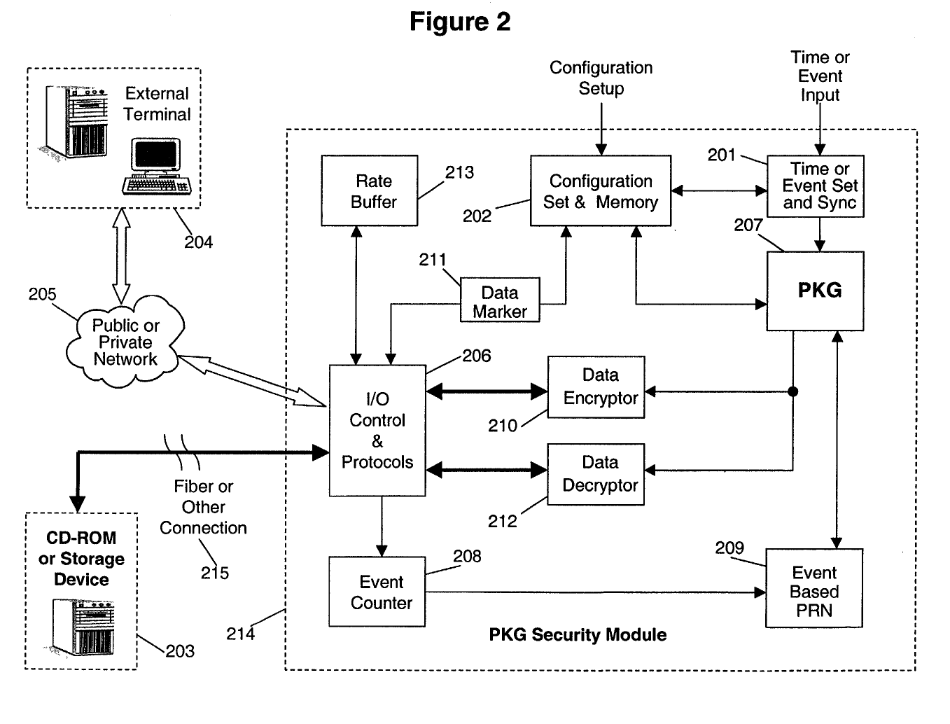

FIG. 2 differs from the FIG. 1 presentation in that it represents an embodiment of a PKG security module specifically designed to perform the cryptographic data storage and retrieval functions. In the FIG. 1 presentation, decryption of incoming data requires three decryptors as outlined in the reference patents in the beginning of this document. This is due to the fact that data may have been encrypted with a standard communications (or transmission) PKG located somewhere in the authorized network. In FIG. 2 however, the stored data about to be decrypted, whether from the same location or another location in a storage area network, also contains or is associated with configuration data (or “data marker”) to configure or synchronize the PKG, whereas said data marker is not present in the incoming data for a FIG. 1 gateway PKG scheme. Thus use of only one decryptor is needed to decrypt the data. For this reason, the PKG security module in FIG. 2 can only be involved in data transmission and storage functions with other PKG security modules that accept the data marker to identify the correct PKG configuration and then set the time or event value for decryption synchronous to the original storage encryption time or event value. Time or event-based periods for frequent key changes throughout the stored content may also be effected via data markers' specification for the PKG configuration.

FIG. 2 also illustrates certain functionality of a PKG used by a client of a storage service provider (SSP). An SSP offers a high capacity storage network to a multitude of clients, at a significant economy of scale. Economy of scale is achieved largely through sharing of memory space and overhead within storage devices. Yet each client wants to be certain that his or her data files cannot be read or accessed by any other client. Conventionally, secured separation of stored data is achieved by physically separating the memory space between different types of data.

One advantage of the present invention is that virtual separation or zoning of files can be achieved, without physically separating memory spaces, by employing separate encryption modes of the different data files within the same physical storage space. More specifically, The PKG security module of FIG. 2 encrypts any incoming content via a configuration unique to that sender and uses only that configuration to retrieve and decrypt that content for the same sender, or his authorized users. To accomplish this same result, the PKG security module can be located at the client to encrypt and data mark or associate the file to be stored with configuration data. The encrypted file can then be sent to the SSP for storage, remaining encrypted throughout the process. Neither the SSP nor any other client possesses the necessary configuration data to decrypt the encrypted file. Instead, the configuration data, created to enable later decryption by the client upon retrieval, may be kept by the client herself or be securely transmitted for storage and retrieval with the encrypted data file. The present invention may be implemented such that a user must present to the SSP the appropriate configuration data in order to retrieve the associated encrypted data file for decryption. At the same time, the configuration data may be used by the system itself to manage and organize the various different data files stored within the SSP. For instance, the system may choose to cluster together or cross reference all the data files that are associated with the same configuration data so that a user may more easily and efficiently later retrieve all the data files that were encrypted using the same configuration data.

In FIG. 2, as in FIG. 1, all the PKGs in the authorized storage network are time or event synchronized via the Time or Event Set and Sync block 201, in order to generate identical encryption and decryption keys within that storage network. It is preferable, however, that all the PKGs in the designated user community are also identically configured in terms of the PKG Configuration Setup values. The PKG security module block 214 has two encryption modes: (a) the data can be encrypted or decrypted with the key applicable for the “present time or event” for the PKG block 207 and changed according to the pre-set key change frequency set for all the PKGs in the storage network, though this may not encrypt or decrypt the data with more than one key (for example, in a case of a key change period of 15 seconds and a file length of less than 15 seconds); and (b) the data can be encrypted or decrypted by a so-called “slice and dice” mode, where even short files can be encrypted or decrypted with a multitude of keys. The PKG block 207, together with the Event Counter block 208 and the Event Based PRN (“pseudo-random number” generator) block 209, accomplishes this. In this encryption mode, the data is first encrypted or decrypted with the key for the “present time or event” of the PKG block 207. Changes to the second and subsequent keys result from the Event Based PRN block 209, which increments to its next output value, based on the Event Counter block 208, for use by the PKG 207 to generate those keys.

Files or data in the clear may be coming from an External Terminal block 204 to I/O Control and Protocols block 206, via the Network connection 205. As the data is being encrypted in Data Encryptor block 210 and sent back to the 1/O Control & Protocols block 206, the Event Counter counts each packet (for example) and sends a signal to the Event Based PRN block 209 to change the key after each increment of a specified number of packets. This can also be done for “number of bits”, “and a host of other such defining events. Before storage in CD-ROM or Storage Device block 203, via Fiber or Other Connection, line 215, the data or file is marked or associated with configuration data by the Data Marker block 211, wherein the configuration data is related to the initial key (i.e., the first encryption key from the PKG block 207). The reason for the two separate generators, a PRN block 207 and a PKG block 209, is to make more efficient the encryption and decryption process. Specifically, the PRN generates the numbers to create keys based on a time or event that stays in sync with all the storage network PKGs and the other generates numbers to create keys based on events generated by the data encryption or decryption process and thus stays in sync with the encryption/decryption upcoming events. The interaction between these two generators also serves to reduce latency in the encryption and decryption process. It is possible, however, for one generator to perform both roles.

The decryption process for encrypted stored files plays the previously described scenario in reverse. The cryptographic configuration data for the data or a file entering the I/O Control & Protocols block 206 is recovered by the Data Marker block 211 before the data is sent for decryption to the Data Decryptor block 212. The Data Marker block 211 sends this information to the Configuration Set & Memory block 202. This data, together with any configuration changes that have been made to the PKG since the file was stored, is sent to the PKG block 207. This sets up the proper generation of the “initial key” that was used to encrypt the file for storage initially. The Event Based PRN block 209 is thus initialized by the PKG block 207 and thus starts at the proper point to enable the PKG block 207 to generate the keys for the encryption event base settings. If that event base is packets (for example), the Event Counter block 208 sends a signal to the Event Based PRN block 209 to change its input to PKG block 207 after each prescribed number of packets is decrypted. The Rate Buffer block 213 serves as a random memory device for data overflow, when the storage rate is slower than the data rate of the incoming traffic. This is also the case when the data rate for encryption and decryption are not the same while data is processed for storage or retrieval, locally or from the network.

All the operating modes described in FIG. 4 apply to the PKG Security Module 214 of FIG. 2, except for the display modes A1, B1, C1, and D1, which are not applicable. Since the operating mode processes were adequately explained for FIG. 1, they are not repeated for FIG. 2.

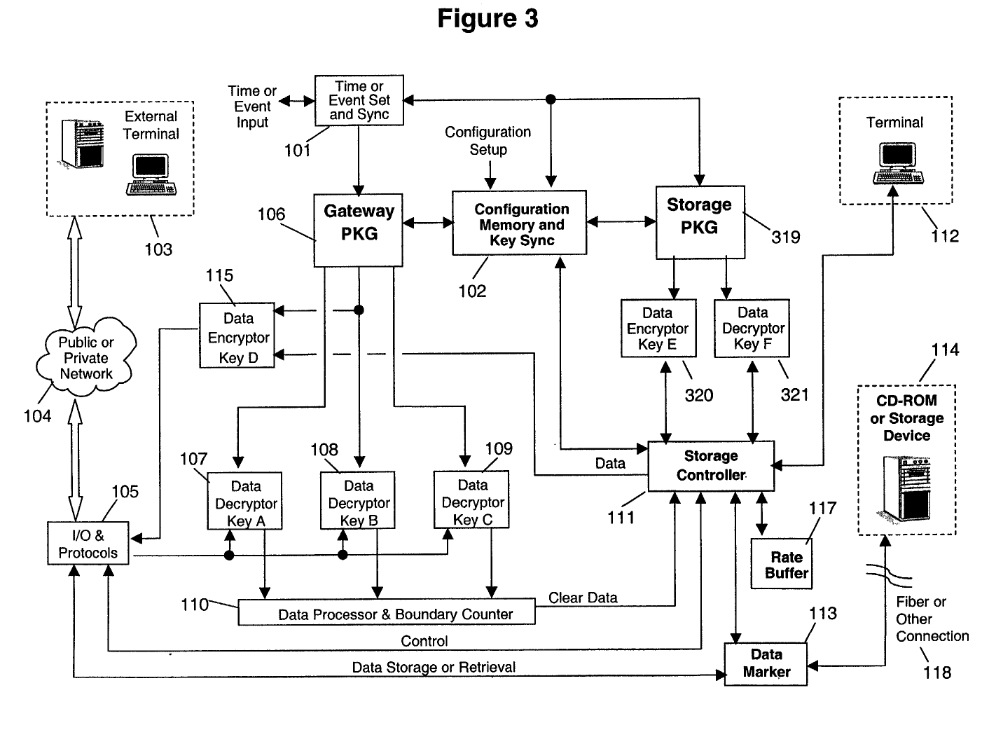

FIG. 3 illustrates another embodiment according to the present invention. FIG. 3 illustrates a communication and storage functionality using separate PKGs for transmission and for storage. In FIG. 3, a gateway PKG 106 associated with access to the storage system handles all encryption/decryption with the communications or transmission network, whether in communication with users or other storage devices. The gateway PKG 106 is configured and synchronized to communicate with those other PKGs within an authorized community. As a result, no data marker is needed to synchronize the gateway PKG 106. Incoming encrypted data may be decrypted by the gateway PKG using a configuration compatible with that for the communicated data or may remain as originally encrypted. The output of the gateway PKG may be displayed or sent to storage. Such data may be stored or received in the clear, stored encrypted, or stored re-encrypted without any initial decryption, all via a storage PKG with encryption configurations that may be unique to storage. If the storage encryption is unique, those storage encryptions are preferably not transmitted over communications networks or shared with users. As a result, management of access to stored data can be separate and distinct from access to communicated data with respect to individual users, sets of users, specific data content, or categories of data content. A data marker for any original communications encryption stored without decryption can be stored for later decryption. Again, time or event-based periodic key changes may be implemented in either the storage or transport encryptions.

Those elements of FIG. 3 with numbers corresponding to elements in FIG. 1 function in the same manner as described in FIG. 1. The system illustrated in FIG. 3 separates the Gateway and Storage PKG functions, block 106 of FIG. 1, into two parts by adding elements 319 through 321 to create a separate storage PKG facility. The original PKG facility, block 106 is now concerned only with data transmission functions. The added Storage PKG 319 can also access the data output of Time or Event Set and Sync block 101 and the Configuration Memory and Key Sync block 102. The new Storage PKG block 319 feeds the appropriate keys to the Data Encryptor Key E block 320 and the Data Decryptor F block 321. For encryption of data and files for storage and decryption of data and files from storage. Only one Encryptor, block 320 and one Decryptor, block 321 are used since there are no communications lags, and the same local time or event value input is used for both encryption and decryption.

If encrypted data received from an External Terminal block 103 via Public or Private Network 104 is stored directly without decryption, it is sent via l/O and Protocols block 105 to the Data Marker 113 for marking or associated with the appropriate cryptographic configuration data and then sent to the CD-ROM or Storage Device block 114 via Fiber or Other Connection line 118. Upon retrieval, such data can be sent with its configuration data via the I/O and Protocols block 105 and the Public or Private Network 104 to the External Terminal block 103 for decryption there. Or it may be sent with its configuration data to the Gateway PKG block 106 for local decryption, as if it had just arrived. If so, it may then be displayed, stored locally in the clear, transmitted in the clear to the External Terminal block 103 , or re-encrypted via Data Encryptor Key D block 115 for the desired disposition thereafter.

It should be noted that the present invention may be embodied in forms other than the preferred embodiments described above without departing from the spirit or essentials characteristics thereof. For instance, although FIGS. 1 to 3 may be interpreted as illustrating a hardware based system, it is entirely feasible, and obvious to one skilled in the art, to incorporate the functions of the various illustrated components within a software program that is executable by a processor or a computer. Similarly, the present application supplies sufficient disclosure for one skilled in the art to implement the various preferred embodiments of the present invention by programming a computer to execute the various necessary steps. Finally, the preferred embodiments are to be considered in all aspects as illustrative and not restrictive, and all changes or alternatives that fall within the meaning and range or equivalency of the claims are intended to be embraced within them.

What we claim:

1. A system for secure data transport and storage, said system comprising:
an in situ key generator;
a data encryptor, said data encryptor connected to said in situ key generator;
a data decryptor, said data decryptor connected to said in situ key generator;
a configuration setup module, said configuration setup module connected to said in situ key generator;
a data marker, said data marker operatively coupled to said configuration setup module;
a synchronization module, said synchronization module operatively coupled to said in situ key generator; and
a controller, said controller operatively coupled to said configuration setup module.

2. The system for secure data transport and storage of claim 1, wherein said data marker is directly connected to said configuration setup module.

3. The system for secure data transport and storage of claim 1, wherein said synchronization module is directly connected to said in situ key generator.

4. The system for secure data transport and storage of claim 1, wherein said controller is directly connected to said configuration module.

5. The system for secure data transport and storage of claim 1, further comprising:
a second data decryptor, said second data decryptor connected to said in situ key generator;
a third data decryptor, said third data decryptor connected to said in situ key generator; and
a data processor connected to said data decryptor, said second data decryptor, and said third data decryptor.

6. The system for secure data transport and storage of claim 1, further comprising an input/output protocol module, said input/output protocol module operatively coupled to said data marker.

7. The system for secure data transport and storage of claim 1, wherein said in situ key generator is a pseudo random key generator.

8. The system for secure data transport and storage of claim 6, wherein said input/output protocol is directly connected to said controller via a control data bus.

9. The system for secure data transport and storage of claim 1, further comprising a rate buffer, said rate buffer operatively coupled to said controller.

10. The system for secure data transport and storage of claim 1, wherein said data marker appends or associates inputted data with configuration data.

11. The system for secure data transport and storage of claim 1, further comprising a pseudo random number generator, said pseudo random number generator connected to said in situ key generator.

12. The system for secure data transport and storage of claim 1, further comprising an event counter, said event counter operatively coupled to said in situ key generator.

13. The system for secure data transport and storage of claim 1, further comprising a computer terminal, said computer terminal operatively coupled to said controller.

14. The system for secure data transport and storage of claim 1, further comprising a storage device, said storage device operatively coupled to said data encryptor.

15. The system for secure data transport and storage of claim 1, further comprising a storage device, said storage device operatively coupled to said data decryptor.

16. The system for secure data transport and storage of claim 1,
wherein said in situ key generator includes a timing device, and
wherein said synchronization module periodically synchronizes said timing device based upon a timing signal received from a timing source.

17. The system for secure data transport and storage of claim 1, wherein said configuration setup module periodically configures said in situ key generator, said configuration being based upon configuration data supplied to the configuration setup module by said data marker.

18. The system for secure data transport and storage of claim 1, wherein said in situ key generator periodically sends encryption keys to said encryptor.

19. The system for secure data transport and storage of claim 1, wherein said in situ key generator periodically sends decryption keys to said decryptor.

20. A system for secure data transport and storage, said system comprising:
a gateway in situ key generator;
a storage in situ key generator;
a configuration setup module, said configuration setup module operatively coupled to said gateway in situ key generator and said storage in situ key generator;
a gateway encryptor, said gateway encryptor operatively coupled to said gateway in situ key generator;
a gateway decryptor; said gateway decryptor operatively coupled to said gateway in situ key generator;
a storage encryptor, said storage encryptor operatively coupled to said storage in situ key generator; and
a storage decryptor, said storage decryptor operatively coupled to said storage in situ key generator.

21. The system for secure data transport and storage of claim 20, further comprising:
a second gateway decryptor;
a third gateway decryptor; and
a data processor, said data processor operatively coupled to said gateway decryptor, said second gateway decryptor, and said third gateway decryptor.

22. The system for secure data transport and storage of claim 20, further comprising a storage controller, said storage controller operatively coupled to said configuration setup module.

23. The system for secure data transport and storage of claim 20, further comprising a synchronization module, said synchronization module operatively coupled to said gateway in situ key generator.

24. The system for secure data transport and storage of claim 22, further comprising a data marker, said data marker operatively coupled to said storage controller.

25. The system for secure data transport and storage of claim 20, further comprising an input/output protocol module, said input/output protocol module operatively coupled to said gateway encryptor and said gateway decryptor.

26. The system for secure data transport and storage of claim 22, further comprising a buffer, said buffer operatively coupled to said storage controller.

27. The system for secure data transport and storage of claim 24, further comprising a storage device, said storage device operatively coupled to said data marker.

28. The system for secure data transport and storage of claim 22, wherein said storage controller is directly connected to said configuration setup module.

29. The system for secure data transport and storage of claim 20, wherein said configuration setup modules periodically configures said gateway in situ key generator.

30. The system for secure data transport and storage of claim 20, wherein said configuration setup modules periodically configures said storage in situ key generator.

31. The system for secure data transport and storage of claim 20, wherein said gateway in situ key generator is synchronized with said storage in situ key generator.

32. The system for secure data transport and storage of claim 20,
wherein said gateway in situ key generator supplies cryptographic keys to said gateway encryptor and said gateway decryptor, and
wherein said storage in situ key generator supplies cryptographic keys to said storage encryptor and said storage decryptor.

33. The system for secure data transport and storage of claim 24, wherein said data marker extracts a configuration data from inputted data, and wherein said data marker sends said extracted configuration data to said configuration setup module.

34. The system for secure data transport and storage of claim 24, wherein said data marker obtains a configuration data that is associated with said inputted data, and wherein said data marker sends said configuration data to said configuration setup module.

35. The system for secure data transport and storage of claim 24, wherein said data marker appends or associates inputted data with a configuration data.

36. The system for secure data transport and storage of claim 20, wherein said gateway in situ key generator is a pseudo random cryptographic key generator.

37. The system for secure data transport and storage of claim 20, wherein said storage in situ key generator is a pseudo random cryptographic key generator.

38. The system for secure data transport and storage of claim 21, wherein said data processor is directly connected to said gateway decryptor, said second gateway decryptor, and said third gateway decryptor.

39. The system for secure data transport and storage of claim 26, wherein said buffer is directly connected to said storage controller.

40. A method for secure data transport and storage, said method comprising the steps of:
receiving data;
generating a cryptographic key using an in situ key generator;
encrypting received data with the generated cryptographic key;
associating the encrypted data with a configuration data; and
sending said encrypted data for storage.

41. The method for secure data transport and storage of claim 40, further comprising the stop of synchronizing an in situ key generator.

42. The method for secure data transport and storage of claim 40, further comprising the step of controlling the timing sequence of said steps of generating the cryptographic key, encrypting the received data, associating the encrypted data with configuration data, and sending the data for storage.

43. The method for secure data transport and storage of claim 40, further comprising the step of determining whether the received data is encrypted.

44. The method for secure data transport and storage of claim 40, wherein the encrypted data is stored in a remote storage area network.

45. The method for secure data transport and storage of claim 40, wherein the encrypted data is stored locally in a storage device.

46. The method for secure data transport and storage of claim 40, further comprising the step of displaying the received data on a computer terminal.

47. The method for secure data transport and storage of claim 40, wherein said in situ key generator is a pseudo random cryptographic key generator.

48. A method for secure data transport and storage, said method comprising the steps of:
receiving data transmission, said received data being encrypted;
generating a decryption key;
decrypting said received data using said generated cryptographic key;
generating an encryption key;
re-encrypting the decrypted data using said generated encryption key;
associating the re-encrypted data with a configuration data; and
sending said re-encrypted data for storage.

49. The method for secure data transport and storage of claim 48, further comprising the steps of:
generating a second decryption key;
generating a third decryption key; and
selecting from among the decryption key, the second decryption key, and the third decryption key to decrypt the received data.

50. The method for secure data transport and storage of claim 49, wherein said decryption key, said second decryption key, and said third decryption key are generated consecutively.

51. A method for secure data storage retrieval, said method comprising the steps of:
retrieving a composite data from at least one storage device, said composite data being encrypted and including stored data and configuration data;
recovering configuration data from said composite data;
configuring an in situ key generator using said recovered configuration data;
generating a decryption key using said configured in situ key generator; and
decrypting said stored data using said generated decryption key.

52. The method for secure data storage retrieval of claim 51, further comprising the step of displaying the decrypted stored data.

53. The method for secure data storage retrieval of claim 51, further comprising the step of sending said stored data to a decryptor.

54. The method for secure data storage retrieval of claim 51, further comprising the steps of:
generating a second decryption key;
generating a third decryption key; and
selecting from among the decryption key, the second decryption key, and the third decryption key to be used to decrypt the stored data.

55. The method for secure data storage retrieval of claim 53, further comprising the steps of:
sending the stored data to a second data decryptor; and
sending the stored data to a third data decryptor.

56. The method for secure data storage retrieval of claim 51, further comprising the steps of synchronizing the timing sequence between said in situ key generator and a data processor.

57. The method for secure data storage retrieval of claim 51, wherein said in situ key generator is a pseudo random cryptographic key generator.

58. A processor-readable medium containing a computer program executable by a processor, said computer program including instructions for performing a method of secure data transport and storage comprising the steps of:
receiving data;
generating a cryptographic key using an in situ key generator;
encrypting received data with the generated cryptographic key;
associating the encrypted data with configuration data; and
sending said encrypted data for storage.

59. The processor-readable medium of claim 58, wherein said in situ key generator is a pseudo random cryptographic key generator.

60. A processor-readable medium containing a computer program executable by a processor, said computer program including instructions for performing a method of secure data transport and storage comprising the steps of:
receiving data transmission, said received data being encrypted;
generating a decryption key;
decrypting said received data using said generated cryptographic key;
generating an encryption key;
re-encrypting the decrypted data using said generated encryption key;
associating the re-encrypted data with configuration data; and
sending said re-encrypted data for storage.

61. A processor-readable medium containing a computer program executable by a processor, said computer program including instructions for performing a method of secure data storage retrieval comprising the steps of:
retrieving a composite data from at least one storage device, said composite data being encrypted and including stored data and configuration data;
recovering configuration data from said composite data;
configuring an in situ key generator using said recovered configuration data;
generating a decryption key using said configured in situ key generator; and
decrypting said stored data using said generated decryption key.

62. The processor-readable medium of claim 61, wherein said in situ key generator is a pseudo random cryptographic key generator.

63. A method for creating virtual separation of data files stored within a single physical storage device by using cryptographic configuration, said method comprising the steps of:
receiving data;
generating a cryptographic key using an in situ key generator;
encrypting received data with the generated cryptographic key;
associating the encrypted data with a configuration data;
sending the encrypted data for storage, wherein the encrypted data may be later retrieved only by using the associated configuration data.

64. The method for creating virtual separation of data files of claim 63, wherein said in situ key generator is a pseudo random cryptographic key generator.

65. A method for managing data files stored in a storage device using cryptographic configuration data, said method comprising the steps of:
receiving data;
generating a cryptographic key using in situ key generator;
encrypting received data with the generated cryptographic key;
associating the encrypted data with a configuration data; and
storing said encrypting data in a storage device, wherein said encrypted data is categorized within the storage device in accordance with the associated configuration data.

66. The method for managing data files of claim 65, wherein said in situ key generator is a pseudo random cryptographic key generator.
